(19) United States
(12) Patent Application Publication
(10) Pub. No.: US 2004/0238997 A1
(43) Pub. Date: Dec. 2, 2004

(54) Method and apparatus for cooling melt spun filaments

(75) Inventors: Stefan Vogel, Neumunster (DE); Jorg Boldt, Boostedt (DE)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Saurer GmbH & Co. KG

(21) Appl. No.: 10/889,907

(22) Filed: Jul. 13, 2004

Related U.S. Application Data
(63) Continuation of application No. PCT/EP03/00632, filed on Jan. 23, 2003.

(30) Foreign Application Priority Data
Jan. 29, 2002 (DE) 102 03 296.3

(51) Int. Cl. B29C 47/60

(52) U.S. Cl. 264/211.22; 425/72.2; 425/143; 425/160; 425/170

(57) ABSTRACT

A method for cooling melt spun filaments, as well as an apparatus for melt spinning a plurality of strand-like filaments. In this method and apparatus, the filaments that are melt spun by means of a spin unit are cooled in a cooling unit by a conditioned cooling air stream. For conditioning the cooling air, a required wet steam is produced by a plurality of steam generators, which connect via parallel lines to a coolant source. With that, it is possible to adapt the number of steam generators to the required quantity of steam such that at least one the steam generators can be disconnected for purposes of maintenance.

### CROSS REFERENCE TO RELATED APPLICATION

The present application is a continuation of international application PCT/EP03/00632, filed 23 Jan. 2003, and which designates the U.S. The disclosure of the referenced application is incorporated herein by reference.

### BACKGROUND OF THE INVENTION

The present invention relates to a method and apparatus for cooling melt spun filaments with a conditioned cooling air stream which is directed into a cooling shaft through which the filaments advance.

In the melt spinning process, a spin unit extrudes a plurality of strand-like filaments from a polymer melt through a plurality of spin holes of a spinneret. After leaving the spin unit, the freshly spun filament strands are cooled, for purposes of being combined to a yarn or bundle of yarns. The cooling is performed by a cooling unit, which comprises a cooling shaft, through which the filaments advance. The cooling shaft connects to a coolant source, which supplies a conditioned air to the cooling shaft. As a result of being conditioned, the cooling air receives a certain moisture content for obtaining an intensive cooling of the filaments. A method and an apparatus of this type are disclosed, for example, in EP 0 046 571 A2.

To obtain a uniform quality of the filaments during the spin process, a particularly high constancy of the cooling parameters is required. Thus, the moisture content of the conditioned cooling air should have in the course of time a constant desired moisture value. However, this can be ensured only, when no interruptions or disturbances occur during the conditioning of the cooling air, which is hard to avoid in the known apparatus with the use of a conditioning system.

It is therefore an object of the invention to provide a method for cooling melt spun filaments as well as an apparatus for melt spinning a plurality of strand-like filaments of the initially described type, in which the spun filaments are constantly cooled by a cooling air with a substantially constant conditioning.

### SUMMARY OF THE INVENTION

The above and other objects and advantages are achieved by the method and apparatus of the present invention and wherein the wet steam that is required for conditioning the cooling air, is generated by a plurality of steam generators, which connect in parallel links to a coolant source. With that it is possible to obtain a uniform and improved conditioning. In addition, there exists a greater flexibility with respect to providing steam. The necessary steam quantity as well as the number of steam generators can be adapted such that even in a partial operation of the steam generators, the steam quantity does not fall below a minimum.

To make available as much as possible a constant steam quantity for conditioning the cooling air, the steam generators may be designed to permit them to be selectively switched from an operating state to an idle state. With that capability, at least one of the steam generators may be put out of operation into an inactive state, while the cooling air is undergoing a conditioning. The steam quantity needed for the conditioning is produced by the steam generators that are kept in an operative state. The inactive steam generator can then be serviced or cleaned without influencing the generated steam quantity.

Since the steam generators require a cleaning after a certain operating period, an advantageous further development of the invention provides that during the conditioning step, the steam generators are alternately switched to the idle state. This ensures that even with the use of two parallel connected steam generators, the steam quantity necessary for conditioning the cooling air is guaranteed on the one hand, and that a periodic cleaning of the steam generator can occur on the other hand.

With the use of three, four, or more steam generators, a preferred further development of the invention provides for switching the steam generators according to a predetermined sequence. To this end, the steam generators connect to a control unit, which ensures that each of the steam generators is successively put into an inactive state. With that, it is possible to run the steam generators, for example, by the rotation principle, one after the other, through an idle phase for maintenance and cleaning, without experiencing significant fluctuations in the generation of the required quantity of steam.

The change for switching the steam generators may advantageously be determined by a cycle time, which results, for example, from the cleaning or maintenance cycle of the steam generators. This ensures that the steam quantity, which each steam generator delivers while being in its operating state, is generated in a highly constant manner.

However, it is also possible to measure the condition of the cooling air by a sensor, preferably at the outlet of the coolant source, and to use the measured value for establishing the time within the sequence for switching the steam generators. This permits the steam generators to maintain their respective operating state with a maximum operating time. Only when, for example, the moisture content of the cooling air falls below a limit value, will the steam generator next in line be switched on.

With the use of few steam generators, it is especially advantageous to use a variant of the method for purposes of guaranteeing a constant steam quantity, and wherein the steam generator will pass through a preparatory state, when switching one of the steam generators from an idle state to an operating state, for approximating, for example, in a preheating phase, the production of a steam quantity that is required for the operating state. Only after completing the preparatory state, will the steam generator next in line be switched from its operating state to its idle state.

### BRIEF DESCRIPTION OF THE DRAWINGS

In the following, further features and advantages of a preferred embodiment of the invention are described in greater detail with reference to FIGS. 1 and 2, in which:

FIG. 1 is a schematic view of an apparatus according to the invention for melt spinning a plurality of strand-like filaments; and

FIG. 2 is a schematic view of a wiring diagram for switching the steam generators shown in FIG. 1.

### DETAILED DESCRIPTION OF THE PREFERRED EMBODIMENTS

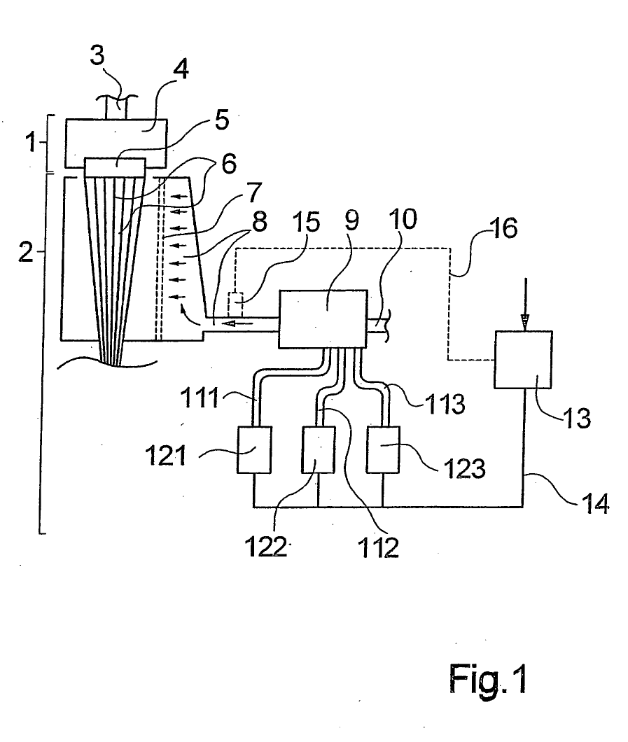

FIG. 1 illustrates an embodiment of an apparatus according to the invention for melt spinning a plurality of strand-like filaments. The apparatus comprises a spin unit 1 and a cooling unit 2 arranged directly downstream of the spin unit 1. The spin unit 1 accommodates a melt supply line 3 that connects, for example, to a melt source (not shown), for example, an extruder or a pump. The melt supply line 3 leads to a spin head 4. The underside of the spin head 4 mounts one or more spin packs 5, which include a plurality of spin holes for extruding a plurality of strand-like filaments 6.

Downstream of the spin pack 5 is a cooling shaft 7 of the cooling unit 2, which surrounds the emerging filaments 6. The cooling shaft 7 connects via an air supply line 8 to the outlet of a source of cooling fluid 9. The source of cooling fluid 9 receives fresh air via an air inlet 10 arranged on the opposite side of the air supply line 8. For conditioning the cooling air inside the source of cooling fluid 9, the source of cooling fluid 9 connects to a plurality of steam generators 121, 122, and 123. To this end, each of the steam generators 121, 122, and 123 connects to the source of cooling fluid 9 via separate parallel steam lines 111, 112, and 113. The steam generators 121, 122, and 123 are activatable by a control unit 13 via a control line 14.

To cool the strand-like filaments 6 that have been freshly spun by the spin unit 1, the source of cooling fluid 9 supplies a conditioned cooling air into the cooling shaft 7 via the air supply line 8. For conditioning the cooling air, the source of cooling fluid 9 receives on the one hand fresh air via the air inlet 10, and on the other hand via at least two steam lines, for example, 111 and 112, steam that is produced by the steam generators 121 and 122. Inside the source of cooling fluid 9, the fresh air is mixed with the wet steam and blown, for example, by a blower as a conditioned cooling air into the air supply line 8.

The steam generators 121, 122, and 123 may be constructed, for example, as cylinders that are filled with water. In these cylinders, water is heated with the aid of electric energy, for example, directly by an electrical line in the water, or by the so-called immersion heater principle. In such steam generators, minerals accumulate in the remaining cylinder water in the course of the operating time. The mineral accumulation has a disturbing effect on the steam generation. Upon exceeding the maximally acceptable mineral content, the steam generator even can be damaged. This requires a cleaning process after a certain operating time of the steam generators. In so doing, the mineral content is reduced by a so-called washout procedure. During the washout procedure, the used water is drained from the steam generator, and fresh water is added. To pass through this cleaning phase, the control unit 13 switches, for example, the steam generator 123 from an operating state to an idle state. For conditioning the cooling air, the source of cooling fluid 9 receives wet steam only from the steam generators 121 and 122.

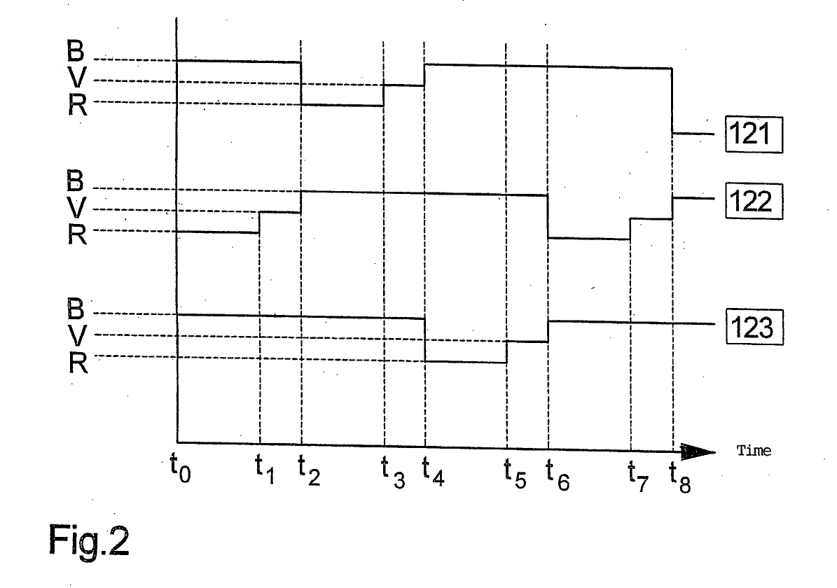

To ensure that each steam generator 121, 122, and 123 passes through a cleaning phase, the control unit 13 switches each of the steam generators 121, 122, and 123 in a certain sequence from an operating state to an idle state, and vice versa. FIG. 2 illustrates a switching diagram for the steam generators 121, 122, and 123. In the diagram, the horizontal represents a time axis. The steam generators 121, 122, and 123 can be selectively switched to an operating state B, a preparatory state V, or an idle state R. In the operating state B, the respective steam generator produces a desired quantity of steam and supplies it to the source of cooling fluid 9. In the preparatory state V, a preheating phase occurs in the particular steam generator after a water change, for purposes of heating the steam generator to the required steam temperature. The preparatory state always follows after completion of an idle state before a restart of the steam generator. In the idle state R, the steam generator passes through the cleaning phase, during which it can be put out of operation for maintenance.

If one starts on the time axis at the time to, the steam generators 121 and 123 will produce steam to make available the quantity of wet steam for conditioning the cooling air. The steam generator 122 is switched to the idle state R and is ready for cleaning or maintenance. At the time t₁, the idle state R of the steam generator 122 is over. The steam generator 122 is switched to the preparatory state V for preheating. At the time t₂, a switchover occurs such that the steam generator 122 is switched from the preparatory state V to the operating state B, and at the same time, the steam generator 121 is switched from the operating state B to the idle state R. Now, the steam generator 121 passes through the idle state R, and upon reaching the time t₃, through the preparatory state V. During this time, the quantity of steam required for conditioning the cooling air is produced by the steam generators 122 and 123. At the time t₄, a next switchover occurs, which returns the steam generator 121 to the operating state B, and the steam generator 123 to the idle state R. The cycle time T for switching the steam generators results from the equation T=t₄−t₂.

In the embodiment shown in FIG. 2, the cycle time is constant, so that after each expiration of a cycle time, a renewed switchover of the steam generators is initiated.

For switching the steam generators, the cycle time could be derived from a maximum operating time of a steam generator, after which a cleaning of the steam generator becomes necessary. Thus, for example, according to the embodiment of FIG. 2, the operating time of the steam generator would total two times the cycle time T.

However, it is also possible to realize the cycle time for switching the steam generators as a function of the condition of the cooling air. To this end, a sensor 15 is provided in FIG. 1 at the outlet of the source of cooling fluid 9. This sensor connects via a signaling line 16 to the control unit 13. The sensor 15 is used to measure, for example, the moisture content of the conditioned cooling air. Within the control unit 13, the signaled measured value of the moisture content undergoes a comparison between actual and desired values, and as a function of the difference, a switchover of the steam generators is initiated. This variant of the method is especially advantageous for attaining a high constancy in the conditioning of the cooling air. Thus, when cooling the filaments, a high evenness is achieved, which results in a very excellent constancy of the physical properties of the spun filaments.

The apparatus of the invention as shown in FIG. 1 is only an example. In particular for conditioning the cooling air, the source of cooling fluid could be connected to at least two steam generators or, however, to four, five, or even more steam generators. The more steam generators are in use for producing the same desired quantity of wet steam, the more constant the steam production becomes in the course of time.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A method of cooling an advancing stream of melt spun filaments comprising the steps of
providing a cooling air source,
conditioning the cooling air from the source with wet steam and then supplying the conditioned air into a cooling shaft that surrounds the advancing filaments, and
wherein the wet steam is produced by a plurality of steam generators which connect via parallel lines to the cooling air source.

2. The method of claim 1, wherein the steam generators are selectively switched from an operating state to an idle state, and vice versa, with at least one steam generator being switched to the idle state during the conditioning step.

3. The method of claim 2, wherein during the conditioning step, the steam generators are alternately switched to the idle state.

4. The method of claim 3, wherein the steam generators are switched in accordance with a predetermined sequence.

5. The method of claim 4, wherein the sequence is determined by a cycle time for cleaning the steam generator, so that the steam generators pass one after the other through a cleaning phase.

6. The method of claim 4, wherein the condition of the cooling air is measured, and that the sequence is determined by the measurement in such a manner that a switchover will occur when the conditioning goes below a limit value.

7. The method of claim 2, wherein when switching one of the steam generators from the idle state to the operating state, the one steam generator passes through a preparatory state, and that the steam generator next in line is switched from the operating state to the idle state only after completion of the preparatory state.

8. An apparatus for melt spinning a plurality of strand-like filaments comprising
a spin unit for extruding the filaments,
a cooling unit for cooling the extruded filaments and which includes a cooling shaft through which the filaments advance,
a source of cooling air connected for delivery to the cooling shaft, and
a plurality of steam generators connected via respective parallel lines to the source of cooling air for conditioning the cooling air upstream of the cooling shaft.

9. The apparatus of claim 8, wherein the steam generators are configured for switching from an operating state to an idle state, and vice versa, with at least one of the steam generators being kept in the idle state while the cooling air is being conditioned.

10. The apparatus of claim 9, wherein the steam generators are configured for alternately switching from the operating state to the idle state, and vice versa.

11. The apparatus of claim 8 further comprising a control unit for controlling the steam generators and which switches the steam generators according to a sequence.

12. The apparatus of claim 11, wherein the control unit includes a timer, which is used to cyclically switch the steam generators.

13. The apparatus of claim 11, further comprising a sensor arranged at the outlet of the coolant source for determining the condition of the cooling air and wherein the sensor connects to the control unit.
